(19) United States
(12) Patent Application Publication
(10) Pub. No.: US 2025/0007417 A1
(43) Pub. Date: Jan. 2, 2025

(54) PARALLEL-CONNECTED POWER CONVERTERS USING PUSH-PULL FEEDBACK NETWORKS

(71) Applicant: POWER INTEGRATIONS, INC., San Jose, CA (US)

(72) Inventors: RAHUL PRABHAKAR JOSHI, Pleasanton, CA (US); Remya KURIAKOSE, Milpitas, CA (US)

(73) Assignee: POWER INTEGRATIONS, INC., San Jose, CA (US)

(21) Appl. No.: 18/736,298

(22) Filed: Jun. 6, 2024

Related U.S. Application Data
(60) Provisional application No. 63/511,287, filed on Jun. 30, 2023.

(51) Int. Cl. H02M 3/335

(52) U.S. Cl. CPC H02M 3/33592

(57) ABSTRACT

Parallel connected power converters using push-pull feedback networks are described herein. The power converters may be switch-mode (switching) power converters (SMPSs) controlled by load dependent signals such that switching frequency increases as a function of load. The load dependent signals (i.e., controller signals) may drive the push-pull feedback networks to adjust the voltage regulation feedback signals and to equalize the output current (i.e., output power) from the parallel-connected power converters.

### CROSS-REFERENCE TO RELATED APPLICATIONS

This application claims priority from U.S. Provisional Application No. 63/511,287 filed on Jun. 30, 2023, hereby incorporated by reference in its entirety.

### BACKGROUND INFORMATION

### Field of the Disclosure

The present invention relates to parallel connected power converters and more particularly to parallel connected flyback converters using push-pull feedback networks.

### Background

Many electronic devices, such as cell phones, laptops, etc., are powered by direct current (dc) power derived from a power supply. Conventional wall outlets generally deliver a high voltage alternating current (ac) power that needs to be converted to regulated dc power in order to be used as a power source for consumer electronic devices. Switch mode power converters, also referred to as switch mode power supplies (SMPSs), are commonly used due to their high efficiency, small size, and low weight.

### BRIEF DESCRIPTION OF THE DRAWINGS

Non-limiting and non-exhaustive embodiments of parallel connected power converters using push-pull feedback networks are described with reference to the following figures, wherein like reference numerals refer to like parts throughout the various views unless otherwise specified.

FIG. 1 illustrates a system of parallel connected power converters using push-pull feedback networks according to an embodiment.

FIG. 2 illustrates a system of parallel connected power converters using push-pull feedback networks according to an embodiment.

FIG. 3A illustrates a push-pull feedback network according to the teachings herein.

FIG. 3B illustrates a push-pull feedback network according to the teachings herein.

FIG. 4 illustrates a system of parallel connected power converters using push-pull feedback networks according to an embodiment.

FIG. 5 illustrates a conceptual flow diagram for providing total power with regulated output voltage to a load according to an embodiment.

FIG. 6 illustrates a system of parallel connected power converters using a push-pull feedback network according to another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the teachings herein. Also, common but well-understood elements that are useful or necessary in a commercially feasible embodiment are often not depicted in order to facilitate a less obstructed view of these various embodiments of parallel connected power converters using push-pull feedback networks.

### DETAILED DESCRIPTION

In the following description, numerous specific details are set forth in order to provide a thorough understanding of parallel connected power converters using push-pull feedback networks. It will be apparent, however, to one having ordinary skill in the art that the specific detail need not be employed to practice the teachings herein. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of a (multiple output) switch-mode power converter system. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a logic circuit, or other suitable components that provide the described functionality. In addition, it is appreciated that the figures provided herewith are for explanation purposes to persons ordinarily skilled in the art and that the drawings are not necessarily drawn to scale.

In the context of the present application, when a transistor is in an “off-state” or “off” the transistor blocks current and/or does not substantially conduct current. Conversely, when a transistor is in an “on-state” or “on” the transistor is able to substantially conduct current. By way of example, in one embodiment, a high-voltage transistor comprises an N-channel metal-oxide-semiconductor (NMOS) field-effect transistor (FET) with the high-voltage being supported between the first terminal, a drain, and the second terminal, a source. In some embodiments an integrated controller circuit may be used to drive a power switch when regulating energy provided to a load. Also, for purposes of this disclosure, “ground” or “ground potential” refers to a reference voltage or potential against which all other voltages or potentials of an electronic circuit or integrated circuit (IC) are defined or measured. Additionally, according to power electronics theory (i.e., power is related to the rate of change of energy), “power” transfer may be implied by “energy” transfer; conversely, “energy” transfer may be implied by “power” transfer.

Often power converters (i.e., power supplies) are specified and/or rated to provide a maximum output power at a specified output voltage. Such a rating or specification limits the maximum current a power converter may deliver to a load.

However, a problem arises in applications where the output power and corresponding load current exceed the maximum output power rating of the power converter; therefore, there is need to find a way to increase the available output power beyond the power converters specified maximum. In theory, connecting power converters in parallel may avail a load-sharing solution.

Unfortunately, in practice power converters may not readily be connected in parallel due to practical and design-related limitations. Often power converters are not designed to be connected in parallel and circuitry for enhancing performance may interfere with a parallel load-sharing configuration. Accordingly, there is a need to find a load-sharing solution to connecting power converters in parallel.

Parallel connected power converters using push-pull feedback networks are described herein. The power converters may be switch-mode (switching) power converters (SMPSs) controlled by load dependent signals such that switching frequency increases as a function of load. The load dependent signals (i.e., controller signals) may drive the push-pull feedback networks to adjust the voltage regulation feedback signals and to equalize the output current (i.e., output power) from the parallel-connected power converters.

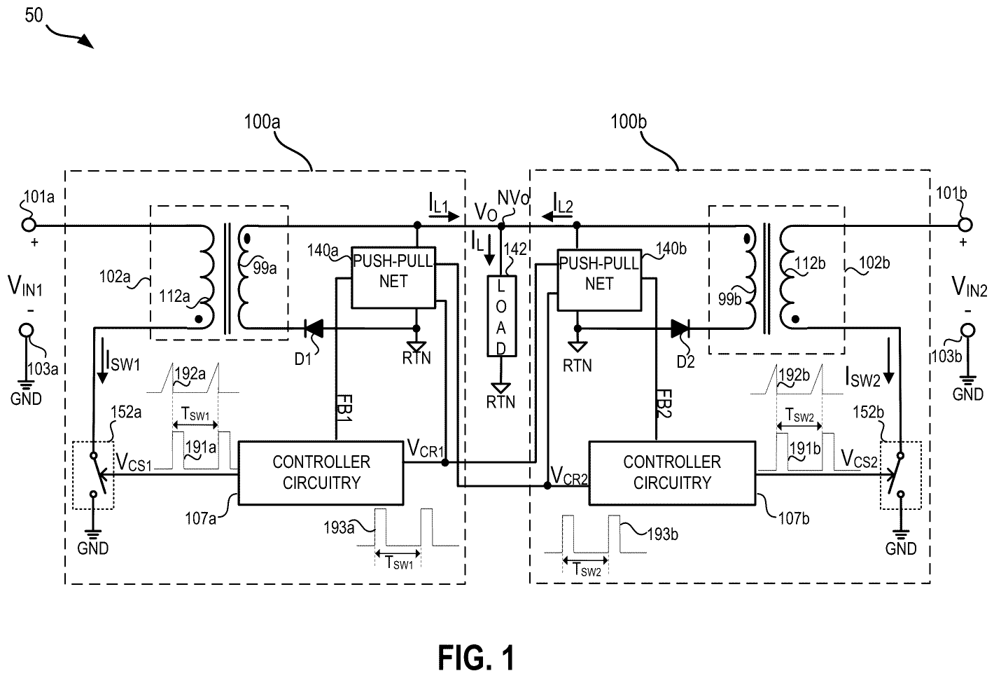

FIG. 1 illustrates a system 50 of parallel connected power converters 100a-b using push-pull feedback networks 140a-b according to an embodiment. Power converter 100a receives input power from a rectified supply voltage V_{IN1} at terminal 101a measured with respect to ground GND at terminal 103a. Power converter 100b receives input power from a rectified supply voltage V_{IN2} at terminal 101b measured with respect to ground GND at terminal 103b.

Although the embodiment of FIG. 1 illustrates power converters 100a-100b as receiving input power from two rectified supply voltages V_{IN1}, V_{IN2}, other configurations are possible. For instance, power converters 100a-100b may receive input power from a single rectified supply voltage (e.g., supply voltage V_{IN1}) without departing from the scope of present disclosure.

The load 142 is connected between the output node NVo and secondary ground and demands an output power determined by the regulated output voltage Vo and load (output) current I_{L}. Power converter 100a and power converter 100b are connected in parallel between the output node NVo and the secondary ground RTN. As such, power converter 100a and power converter 100b may share the load (i.e., the total load current I_{L}).

As illustrated, power converter 100a provides an output current I_{L1} and power converter 100b provides an output current I_{L2} to the load. According to circuit theory, the total load current I_{L} may equal the sum of output currents I_{L1}, I_{L2} such that the power converter 100a-100b share the total output power (i.e., output voltage Vo times load current I_{L}).

Also as illustrated, power converter 100a and power converter 100b have a flyback configuration. Power converter 100a includes an energy transfer element 102a (e.g., a transformer), a secondary diode D1, controller circuit 107a, and a primary switch 152a. The energy transfer element 102a comprises a primary winding 112a and a secondary winding 99a. The primary switch 152a is electrically coupled to the primary winding 112a; energy (i.e., power) may be transferred to the secondary winding 99a according to a switching cycle of primary switch 152a.

For instance, the controller circuit 107a may provide a gate signal V_{CS1} to turn primary switch 152a on and off. According to switch mode power supply (SMPS) theory, the gate signal V_{CS1} may transition (i.e., may vary) according to switching waveform 191a; in turn, a primary current I_{SW1} energizes primary winding 112a according to switching waveform 192a. As illustrated, both switching waveforms 191a-192a switch according to a switching cycle of period T_{SW1}.

Also, according to SMPS theory, the controller circuit 107a may, in response to a feedback signal FB1, adjust the switching cycle (i.e., the period T_{SW1}) so that the power is delivered to the load 142 with regulated output voltage Vo. For instance, as the load demand increases, the feedback signal FB1 may droop; and in response, the controller circuit 107a may increase and/or adjust the frequency of gate signal V_{CS1}.

Similarly, power converter 100b includes an energy transfer element 102b (e.g., a transformer), a secondary diode D2, controller circuit 107b, and a primary switch 152b. The energy transfer element 102b comprises a primary winding 112b and a secondary winding 99b. The primary switch 152b is electrically coupled to the primary winding 112b; energy (i.e., power) may be transferred to the secondary winding 99b according to a switching cycle of primary switch 152b.

For instance, the controller circuit 107b may provide a gate signal V_{CS2} to turn primary switch 152b on and off. According to switch mode power supply (SMPS) theory the gate signal V_{CS2} may transition (i.e., may vary) according to switching waveform 191b; in turn, a primary current I_{SW2} energizes primary winding 112b according to switching waveform 192b. As illustrated, both switching waveforms 191b-192b switch according to a switching cycle of period T_{SW2}.

Also, according to SMPS theory, the controller circuit 107b may, in response to a feedback signal FB2, adjust the switching cycle (i.e., the period T_{SW2}) so that the power is delivered to the load 142 with regulated output voltage Vo. For instance, as the load demand increases, the feedback signal FB2 may droop; and in response, the controller circuit 107b may increase and/or adjust the frequency of gate signal V_{CS2}.

According to the teachings herein, power converter 100a may include a push-pull feedback network 140a and power converter 100b may include a push-pull feedback network 140b. As illustrated, push-pull feedback network 140a and push-pull feedback network 140b may receive a control signal V_{CR1} from controller circuit 107a and a control signal V_{CR2} from controller circuit 107b. Control signals V_{CR1} and V_{CR2} may vary with load demand (i.e., the load current Io). For instance, control signal V_{CR1} may transition according to a switching waveform 193a of period T_{SW1}; and the corresponding switching frequency, as related to the reciprocal of period T_{SW1}, may be a monotonically increasing function of the load demand. Similarly, control signal V_{CR2} may transition according to a switching waveform 193b of period T_{SW2}; and the corresponding switching frequency, as related to the reciprocal of period T_{SW2}, may be a monotonically increasing function of the load demand.

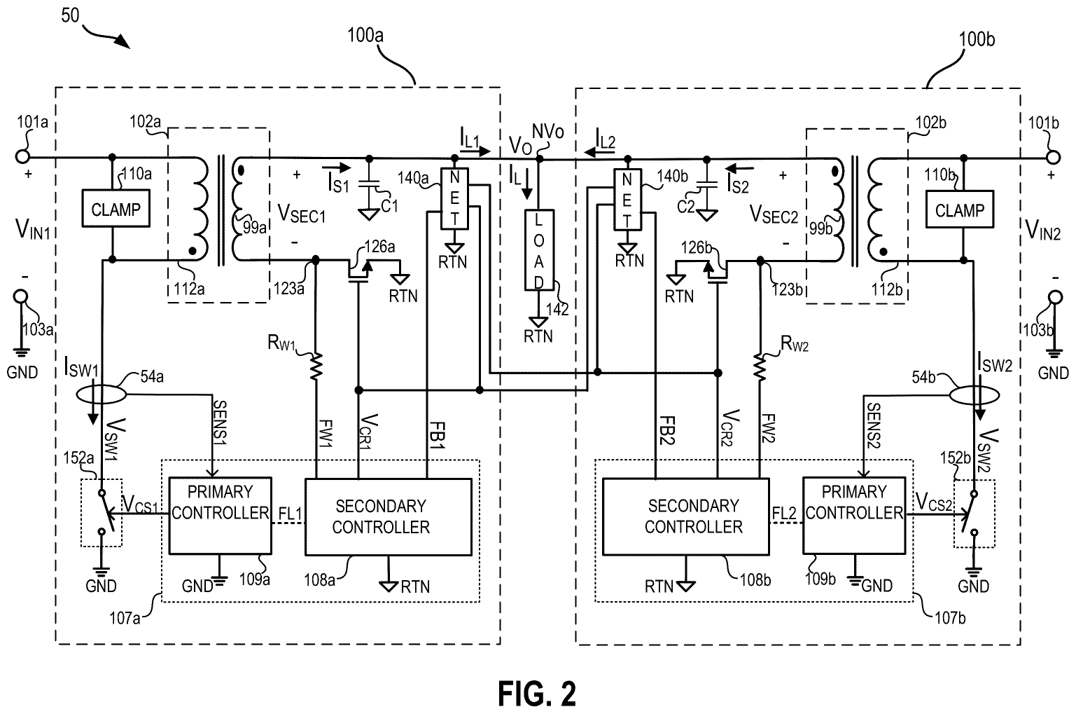

FIG. 2 illustrates a system 50 of parallel connected power converters 100a-b using push-pull feedback networks 140a-b according to an embodiment. The embodiment of FIG. 2 is like that of FIG. 1, except the power converters 100a-b illustrate additional and/or alternate components.

Power converter 100a includes a primary clamp 110a, an output capacitor C1, a primary current sense element 54a, and a resistor R_{W1}. Additionally, an N-type field effect transistor (NFET) 126a replaces diode D1 and may operate as a synchronous rectifier (SR). Accordingly, NFET 126a may also be referred to as a synchronous rectifier 126a without departing from the scope of the present disclosure.

The controller circuit 107a includes a secondary controller 108a and a primary controller 109a. The primary controller 109a is referenced to ground GND and may receive a current sense signal SENS1 from the primary current sense element 54a. In one application, the primary controller 109a may turn off the primary switch 152a when the primary current I_{SW1} exceeds a current limit (e.g., ten amperes). Alternatively, and additionally, the primary controller 109a may turn on the primary switch 152a in response to a request signal FL1 from the secondary controller 108a.

The secondary controller 108a is referenced to secondary ground RTN. As illustrated, the secondary controller 108a receives a forward signal FW1 from a forward node 123a via resistor R_{W1}. Additionally, the secondary controller 108a may provide control signal V_{CR1} and receive feedback signal FB1. In response to the feedback signal FB1, the secondary controller may send a request signal FL1 to the primary controller 109a when there is a demand for more output current I_{L1}.

Similarly, power converter 100b includes a primary clamp 110b, an output capacitor C2, a primary current sense element 54b, and a resistor R_{W2}. Additionally, an N-type field effect transistor (NFET) 126b replaces diode D2 and may operate as a synchronous rectifier (SR). Accordingly, NFET 126b may also be referred to as a synchronous rectifier 126b without departing from the scope of the present disclosure.

The controller circuit 107b includes a secondary controller 108b and a primary controller 109b. The primary controller 109b is referenced to ground GND and may receive a current sense signal SENS2 from the primary current sense element 54b. In one application, the primary controller 109b may turn off the primary switch 152b when the primary current I_{SW2} exceeds a current limit (e.g., ten amperes). Alternatively, and additionally, the primary controller 109b may turn on the primary switch 152b in response to a request signal FL2 from the secondary controller 108a.

The secondary controller 108b is referenced to secondary ground RTN. As illustrated, the secondary controller 108b receives a forward signal FW2 from a forward node 123b via resistor R_{W2}. Additionally, the secondary controller 108b may provide control signal V_{CR2} and receive feedback signal FB2. In response to the feedback signal FB2, the secondary controller may send a request signal FL2 to the primary controller 109b when there is a demand for more output current I_{L2}.

Additionally, power converters 100a-b may be of the same type and have matched components and/or similar configurations. For instance, primary clamps 110a-b, output capacitors C1-C2, primary current sense elements 54a-b, and/or resistors R_{W1}-R_{W2} may have the same values and/or characteristics. Alternatively, and additionally, the controller circuits 107a-b may be of the same type and have matched and/or similar configurations. For instance, controller circuit 107a may be the same type and have the same datasheet as controller circuit 107b.

According to the teachings herein, the push-pull feedback networks 140a-b may receive control signals V_{CR1}, V_{CR2}. The switching frequency of control signal V_{CR1} may be a monotonically increasing function of output power relating to output current I_{L1}; and the switching frequency of control signal V_{CR2} may be a monotonically increasing function of output power relating to output current I_{L2}.

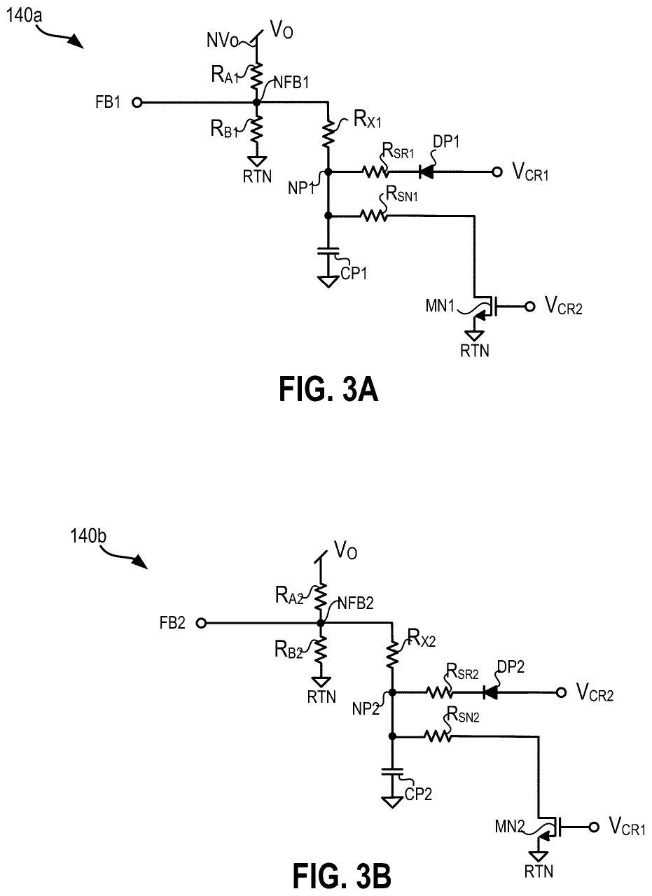

As discussed below with regards to FIG. 3A and FIG. 3B, by virtue of their functional dependence on frequency, the control signals V_{CR1}, V_{CR2} may give rise to push-pull feedback whereby the feedback signals FB1, FB2 become a function of the frequency of V_{CR1} and the frequency of V_{CR2}. Also, according to the teachings herein, in response to the control signals V_{CR1}, V_{CR2}, the push-pull feedback networks 140a, 140b may provide the feedback signals FB1, FB2 so that the load current Io is shared equally by output current I_{L1} and output current I_{L2}.

FIG. 3A illustrates a push-pull feedback network 140a according to the teachings herein. The push-pull feedback network 140a includes a divider resistor R_{A1}, a divider resistor R_{B1}, an auxiliary resistor R_{X1}, a path resistor R_{SR1}, a path resistor R_{SN1}, a diode DP1, a capacitor CP1, and an NFET MN1. Resistor R_{A1} is electrically coupled between output node NVo and a feedback node NFB1; and resistor R_{B1} is electrically coupled between the feedback node NFB1 and return ground RTN. As such, the feedback signal FB1 may be dependent, at least in part, on divider resistors R_{A1}, R_{B1} and on the output voltage Vo.

As illustrated, auxiliary resistor R_{X1} is electrically coupled between node NP1 and feedback node NFB1, and capacitor CP1 is electrically coupled between node NP1 and secondary ground RTN. Additionally, path resistor R_{SR1} is electrically coupled between node NP1 and the cathode of diode DP1; and path resistor R_{SN1} is electrically coupled between node NP1 and the drain of NFET MN1.

Also, as illustrated, the anode of diode DP1 receives control signal V_{CR1}. Accordingly, the feedback signal FB1 may also be dependent, at least in part, on control signal V_{CR1} and on auxiliary resistor R_{X1}, path resistor R_{SR1}, and capacitor CP1. Additionally, the feedback signal FB1 may depend, at least in part, on the switching frequency and amplitude of control signal V_{CR1}. (e.g., switching waveform 193a).

As illustrated, the source of NFET MN1 is electrically coupled to secondary ground RTN, and the gate of NFET MN1 receives control signal V_{CR2}. As such, the NFET MN1 may pull node NP1 to the secondary ground RTN when control signal V_{CR2} causes NFET MN1 to conduct. Thus, the feedback signal FB1 may also depend, at least in part, on the path resistor R_{SN1}, the switching frequency and the amplitude of control signal V_{CR2}. (e.g., switching waveform 193b).

According to the teachings herein, the dependence of the feedback signal FB1 on control signals V_{CR1} and V_{CR2} may be such that the output current I_{L1} is adjusted to be substantially equal to that of output current I_{L2}. Accordingly, the control signals V_{CR1} and V_{CR2} may be such that the power delivered by power converter 100a, is adjusted to be substantially equal to the power delivered by power converter 100b.

FIG. 3B illustrates a push-pull feedback network 140b according to the teachings herein. The push-pull feedback network 140b includes a divider resistor R_{A2}, a divider resistor R_{B2}, an auxiliary resistor R_{X2}, a path resistor R_{SR2}, a path resistor R_{SN2}, a diode DP2, a capacitor CP2, and an NFET MN2. Resistor R_{A2} is electrically coupled between output node NVo and a feedback node NFB2; and resistor R_{B2} is electrically coupled between the feedback node NFB2 and return ground RTN. As such, the feedback signal FB2 may be dependent, at least in part, on divider resistors R_{A2}, R_{B2} and on the output voltage Vo.

As illustrated, auxiliary resistor R_{X2} is electrically coupled between node NP2 and feedback node NFB2, and capacitor CP2 is electrically coupled between node NP2 and secondary ground RTN. Additionally, path resistor R_{SR2} is electrically coupled between node NP2 and the cathode of diode DP2; and path resistor R_{SN2} is electrically coupled between node NP2 and the drain of NFET MN2.

Also, as illustrated the anode of diode DP2 receives control signal V_{CR2}. Accordingly, the feedback signal FB2 may also be a voltage dependent, at least in part, on control signal V_{CR2} and on auxiliary resistor R_{X2}, path resistor R_{SR2}, and capacitor CP2. Additionally, the feedback signal FB2 may depend, at least in part, on the switching frequency and amplitude of control signal V_{CR2}. (e.g., switching waveform 193b).

As illustrated, the source of NFET MN2 is electrically coupled to secondary ground RTN, and the gate of NFET MN2 receives control signal V_{CR1}. As such, the NFET MN2 may pull node NP2 to the secondary ground RTN when control signal V_{CR1} causes NFET MN2 to conduct. Thus, the feedback signal FB2 may also depend, at least in part, on the path resistor R_{SN2}, the switching frequency and the amplitude of control signal V_{CR1}. (e.g., switching waveform 193a).

According to the teachings herein, the dependence of the feedback signal FB1 on control signals V_{CR1} and V_{CR2} may be such that the output current I_{L2} is adjusted to be substantially equal to that of output current I_{L1}. Accordingly, the control signals V_{CR1} and V_{CR2} may be such that the power delivered by power converter 100b, is adjusted to be substantially equal to the power delivered by power converter 100a.

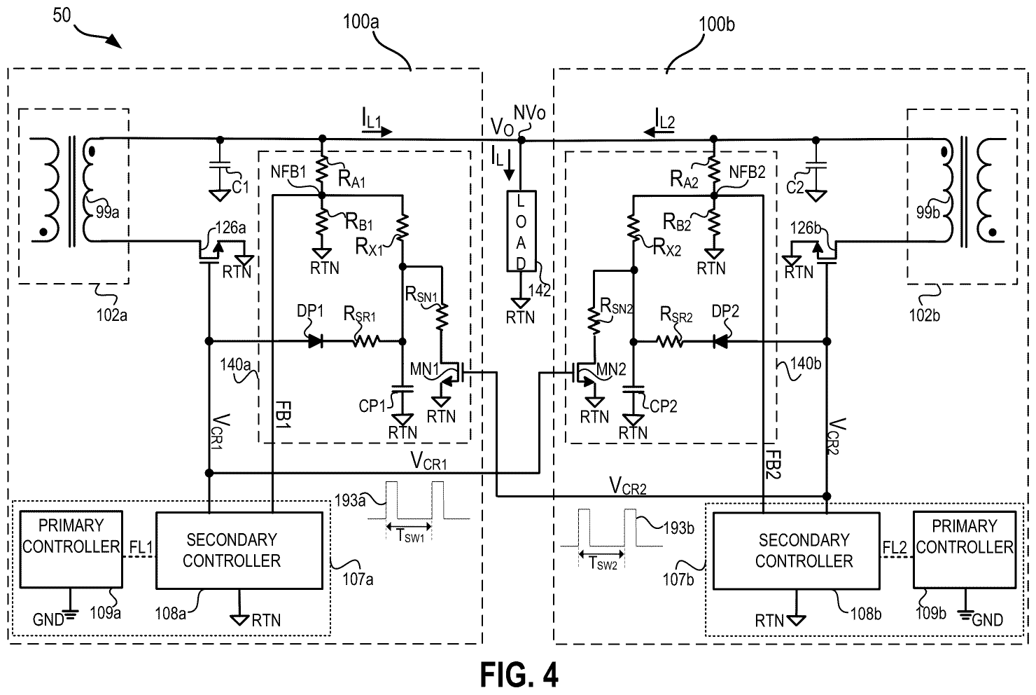

FIG. 4 illustrates a system 50 of parallel connected power converters 100a-b using push-pull feedback networks 140a-b according to an embodiment. The embodiment of FIG. 4 is like that of FIG. 2, except the power converters 100a-b are drawn to provide a less obstructed view of the push-pull feedback networks 140a-b.

As illustrated, feedback network 140a may receive the output voltage Vo, control signal V_{CR1}, and control signal V_{CR2}, and may provide the feedback signal FB1. Therefore, in accordance with circuit theory, the feedback signal FB1 may depend on output voltage Vo, control signal V_{CR1}, and control signal V_{CR2}. A direct current (DC) analysis with control signals V_{CR1}, V_{CR2} set to the secondary ground potential, relates the feedback signal FB1 to the output voltage Vo as a function of a divider ration of divider resistors R_{A1}, R_{B1}.

According to the teachings herein, the control signals V_{CR1}, V_{CR2} may, by virtue of their alternating current (AC) switching behavior, adjust the feedback signal FB1 so that the output power and corresponding output current (i.e., the output current I_{L1}) of power converter 100a may be shared equally, or approximately shared equally, with the output power and corresponding output current (i.e., the output current I_{L2}) of power converter 100b.

As illustrated, control signal V_{CR1}, by virtue of its electrical connection at the anode of diode DP1 and its characteristic switching behavior (e.g., waveform 193a), may vary the feedback signal FB1. For instance, the control signal V_{CR1} may push the feedback signal FB1 higher with increasing frequency (i.e., with decreasing period T_{SW1}). In this regard, as provided to feedback network 140a, the control signal V_{CR1} may function as a push signal V_{CR1}. Accordingly, with regards to feedback network 140a, the control signal V_{CR1} may also be referred to as a push signal V_{CR1} without departing from the scope of the present disclosure.

Alternatively, and additionally, the control signal V_{CR2}, by virtue of its electrical connection to the gate of NFET MN1 and its characteristic switching behavior (e.g., waveform 193b), may also vary the feedback signal FB1. For instance, the control signal V_{CR2} may cause NFET MN1 to pull the feedback signal FB1 lower with increasing frequency (i.e., with decreasing period T_{SW2}). In this regard, as provided to feedback network 140a, the control signal V_{CR2} may function as a pull signal V_{CR2}. Accordingly, with regards to feedback network 140a, the control signal V_{CR2} may also be referred to as a pull signal V_{CR2} without departing from the scope of the present disclosure.

Similarly, as illustrated, feedback network 140b may receive the output voltage Vo, control signal V_{CR2}, and control signal V_{CR1}, and may provide the feedback signal FB2. Therefore, in accordance with circuit theory, the feedback signal FB2 may depend on output voltage Vo, control signal V_{CR1}, and control signal V_{CR2}. A direct current (DC) analysis with control signals V_{CR1}, V_{CR2} set to the secondary ground potential, relates the feedback signal FB2 to the output voltage Vo as a function of a divider ration of divider resistors R_{A2}, R_{B2}.

According to the teachings herein, the control signals V_{CR1}, V_{CR2} may, by virtue of their alternating current (AC) switching behavior, adjust the feedback signal FB2 so that the output power and corresponding output current (i.e., the output current I_{L2}) of power converter 100b may be shared equally, or approximately shared equally, with the output power and corresponding output current (i.e., the output current I_{L1}) of power converter 100a.

As illustrated, control signal V_{CR2}, by virtue of its electrical connection at the anode of diode DP2 and its characteristic switching behavior (e.g., waveform 193b), may vary the feedback signal FB2. For instance, the control signal V_{CR2} may push the feedback signal FB2 higher with increasing frequency (i.e., with decreasing period T_{SW2}). In this regard, as provided to feedback network 140b, the control signal V_{CR2} may function as a push signal V_{CR2}. Accordingly, with regards to feedback network 140b, the control signal V_{CR2} may also be referred to as a push signal V_{CR2} without departing from the scope of the present disclosure.

Alternatively, and additionally, the control signal V_{CR1}, by virtue of its electrical connection to the gate of NFET MN2 and its characteristic switching behavior (e.g., waveform 193a), may also vary the feedback signal FB2. For instance, the control signal V_{CR2} may cause NFET MN2 to pull the feedback signal FB2 lower with increasing frequency (i.e., with decreasing period T_{SW1}). In this regard, as provided to feedback network 140b, the control signal V_{CR1} may function as a pull signal V_{CR1}. Accordingly, with regards to feedback network 140a, the control signal V_{CR1} may also be referred to as a pull signal V_{CR1} without departing from the scope of the present disclosure.

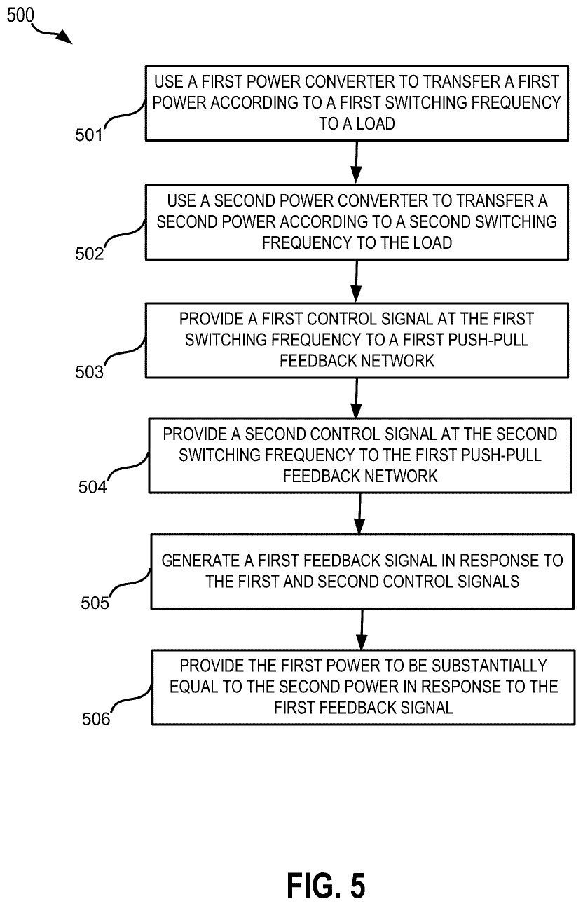

FIG. 5 illustrates a conceptual flow diagram 500 for providing total power with regulated output voltage Vo to a load 142 according to an embodiment. Step 501 may correspond with using a first power converter (e.g., power converter 100a). The first power may correspond with an output power relating to an output current (e.g., output current I_{L1}). The first power may be transferred based on the frequency of a gate signal (e.g., gate signal V_{CS1}).

Step 502 may correspond with using a second power converter (e.g., power converter 100b). The second power may correspond with an output power relating to an output current (e.g., output current I_{L2}). The first power may be transferred based on the frequency of a gate signal (e.g., gate signal V_{CS2}).

Step 503 may correspond with providing a first control signal (e.g., control signal V_{CR1}) at a first switching frequency (see, e.g., waveform 193a). The first control signal may be applied to a first push-pull feedback network (e.g., push-pull feedback network 140a).

Step 504 may correspond with providing a second control signal (e.g., control signal V_{CR2}) at a second switching frequency (see, e.g., waveform 193b). The second control signal may also be applied to the first push-pull feedback network (e.g., push-pull feedback network 140a).

Step 505 may correspond with providing a first feedback signal (e.g., feedback signal FB1) in response to the first and second control signals.

Step 506 may correspond with load sharing. Namely, in response to the first feedback (e.g., feedback signal FB1), the first power may be substantially equal to the second power.

In one example, a power converter system (e.g., system 50) comprises a first power converter (e.g., power converter 100a), a second power converter (e.g., power converter 100b), and a first push-pull feedback network (e.g., push-pull feedback network 140a).

The first power converter comprises a first controller circuit (e.g., controller circuit 107a). The first controller circuit is configured to drive a first switch (e.g., primary switch 152a) according to a first switching frequency (see, e.g., waveforms 191a, 192a in FIG. 1) such that the first power converter transfers a first power (i.e., output power) to a load 142. The first power may be the output power relating to output current I_{L1}.

The second power converter comprises a second controller circuit (e.g., controller circuit 107b). The second controller circuit is configured to drive a second switch (e.g., primary switch 152b) according to a second switching frequency (see, e.g., waveforms 191b, 192b in FIG. 1) such that the second power converter transfers a second power (i.e., output power) to the load 142. The second power may be the output power relating to output current I_{L2}.

The first push-pull feedback network is configured to receive a first push signal (e.g., control signal V_{CR2}) at the second switching frequency and a first pull signal (control signal V_{CR1}) at the first switching frequency. In response, the first push-pull feedback network provides the first feedback signal (e.g., feedback signal FB1) to the first controller circuit such that the first power is substantially equal to the second power.

In another example the power converter system comprises a second push pull feedback network (e.g., push-pull feedback network 140b.

The second push-pull feedback network is configured to receive a second push signal (e.g., control signal V_{CR1}) at the first switching frequency and a second pull signal (control signal V_{CR2}) at the second switching frequency. In response, the second push-pull feedback network provides the second feedback signal (e.g., feedback signal FB2) to the second controller circuit such that the second power is substantially equal to the first power.

Although the embodiments of FIG. 1, FIG. 2, and FIG. 4 illustrate two push-pull feedback networks 140a-b; other configurations may be possible.

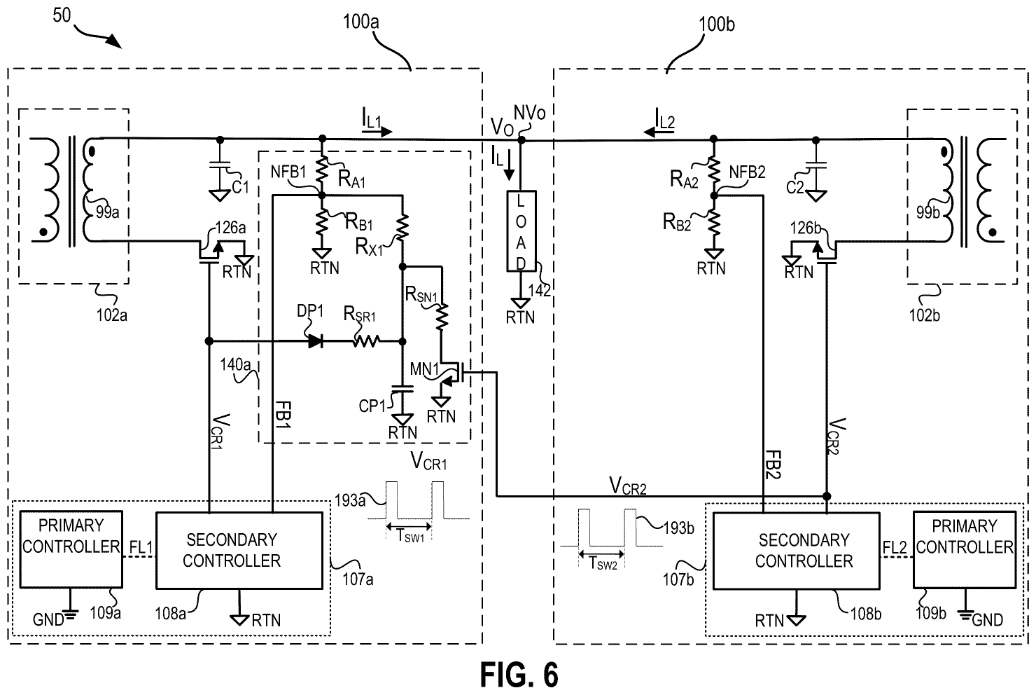

For instance, FIG. 6 illustrates a system 50 of parallel connected power converters 100a-b using a push-pull feedback network 140a according to another embodiment. The embodiment of FIG. 6 is like that of FIG. 4, except load sharing is accomplished using one push-pull feedback network 140a. As illustrated, feedback signal FB2 is derived from a resistor divider formed by divider resistor R_{A2} and divider resistor R_{B2}.

### CONCLUSION

The above description of illustrated examples of the present disclosure, including what is described in the Abstract, are not intended to be exhaustive or to be limitation to the precise forms disclosed. While specific embodiments of and examples for parallel connected power converters using push-pull feedback networks are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings herein.

The foregoing description may refer to elements or features as being “connected,” “electrically connected,” and/or “coupled” together. As used herein, unless expressly stated otherwise, “electrically connected” and/or “connected” mean that one element/feature is directly or indirectly connected to another element/feature, and not necessarily mechanically. Likewise, unless expressly stated otherwise, “electrically coupled” and/or “coupled” mean that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

Moreover, conditional language used herein, such as, among others, “can,” “could,” “might,” “may,” “e.g.,” “for example,” “such as” and the like, unless specifically stated otherwise or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while the disclosed embodiments are presented in a given arrangement, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. Accordingly, the scope of the present invention is defined only by reference to the appended claims.

Although the claims presented here are in single dependency format for filing at the USPTO, it is to be understood that any claim may depend on any preceding claim of the same type except when that is clearly not technically feasible.

1. A power converter system comprising:
a first power converter comprising a first controller circuit, wherein the first controller circuit is configured to drive a first switch according to a first switching frequency such that the first power converter transfers a first power to a load;
a second power converter comprising a second controller circuit, wherein the second controller circuit is configured to drive a second switch according to a second switching frequency such that the second power converter transfers a second power to the load; and
a first push pull feedback network configured to receive a first push signal at the second switching frequency, to receive a first pull signal at the first switching frequency, and in response to provide a first feedback signal to the first controller circuit such that the first power is substantially equal to the second power.

2. The power converter system of claim 1, wherein the first power converter is a flyback converter.

3. The power converter system of claim 1, wherein the second power converter is a flyback converter.

4. The power converter system of claim 1, wherein the first controller circuit comprises: a primary controller and a secondary controller.

5. The power converter system of claim 1, wherein the first power converter is configured to provide a first output current to the load.

6. The power converter system of claim 5, wherein the second power converter is configured to provide a second output current to the load.

7. The power converter system of claim 6, wherein the first output current is substantially equal to the second output current.

8. The power converter system of claim 6, wherein the first switching frequency monotonically increases as a function of the first output current.

9. The power converter system of claim 6, wherein the second switching frequency monotonically increases as a function of the second output current.

10. The power converter system of claim 6, wherein the power converter system is configured to provide a regulated output voltage to the load.

11. The power converter system of claim 1, further comprising:
a second push-pull feedback network configured to receive a second push signal at the first switching frequency, to receive a second pull signal at the second switching frequency, and in response to provide a second feedback signal to the second controller circuit such that the second power is substantially equal to the first power.

12. The power converter system of claim 11, wherein the first controller circuit is configured to provide the first push signal to a gate of a first N-channel field effect transistor (NFET), and wherein the first NFET is a first synchronous rectifier.

13. The power converter system of claim 12, wherein the second controller circuit is configured to provide the second push signal to a gate of a second N-channel field effect transistor (NFET), and wherein the second NFET is a second synchronous rectifier.

14. The power converter system of claim 12, wherein the first push signal is the second pull signal.

15. The power converter system of claim 12, wherein the second push signal is the first pull signal.

16. A method of providing a total power with regulated output voltage to a load comprising:
using a first power converter to transfer a first power according to a first switching frequency to the load;
using a second power converter to transfer a second power according to a second switching frequency to the load;
providing a first control signal at the first switching frequency to a first push-pull feedback network;
providing a second control signal at the second switching frequency to the first push-pull feedback network;
generating a first feedback signal in response to the first and second control signals; and
providing the first power to be substantially equal to the second power in response to the first feedback signal.

17. The method of claim 16 further comprising:
providing the first control signal at the first switching frequency to a second push-pull feedback network;
providing the second control signal at the second switching frequency to the second push-pull feedback network;
generating a second feedback signal in response to the first and second control signals; and
providing the second power to be substantially equal to the first power in response to the second feedback signal.

18. The method of claim 17, wherein the first power converter is a flyback converter.

19. The method of claim 17, wherein the second power converter is a flyback converter.

20. The method of claim 17, wherein the first switching frequency monotonically increases as a function of the first power.

21. The method of claim 17, wherein the second switching frequency monotonically increases as a function of the second power.

22. A power converter system configured to provide a regulated output voltage to a load and comprising:
a first power converter comprising a first controller circuit, wherein the first controller circuit is configured to drive a first switch according to a first switching frequency such that the first power converter provides a first current to the load;
a second power converter comprising a second controller circuit, wherein the second controller circuit is configured to drive a second switch according to a second switching frequency such that the second power converter provides a second current to the load; and
a first push pull feedback network configured to receive a first push signal at the second switching frequency, to receive a first pull signal at the first switching frequency, and in response to provide a first feedback signal to the first controller circuit such that the first current is substantially equal to the second current.

23. The power converter system of claim 22, further comprising:
a second push-pull feedback network configured to receive a second push signal at the first switching frequency, to receive a second pull signal at the second switching frequency, and in response to provide a second feedback signal to the second controller circuit such the second current is substantially equal to the first current.
